(19) United States
(12) Patent Application Publication
(10) Pub. No.: US 2007/0094619 A1
(43) Pub. Date: Apr. 26, 2007

(54) Cursor management method and program for the same

(76) Inventor: Takuya Shirai, Osaka (JP)

Correspondence Address: GLOBAL IP COUNSELORS, LLP, 1233 20TH STREET, NW, SUITE 700, WASHINGTON, DC, 20036-2680, US

(21) Appl. No.: 11/258,246

(22) Filed: Oct. 26, 2005

(51) Int. Cl. G06F 3/00

(52) U.S. Cl. 715/860

(57) ABSTRACT

When a user inputs an instruction to execute cursor addition processing, an information processing unit (2a) of a computer (2) writes cursor information consisting of cursor number and index information indicating a position of a current cursor and the like, to RAM (2b), and registers the current cursor in memory. When the user inputs an instruction to execute cursor deletion processing, cursor information of a specified registered cursor is deleted from the RAM (2b). When the user inputs an instruction to execute cursor selection processing, a cursor selected from among registered cursors is set as an operative cursor, and the current cursor is moved to a position in the index information of the operative cursor, stored in the RAM (2b).

### FIELD OF THE INVENTION

The present invention relates to a cursor displayed on a screen of a display device, more particularly, to cursor management technology for managing a display and operations thereon, together with input and the like, at a cursor position.

### BACKGROUND INFORMATION

In a display device of a computer or the like, on which a user performs an input operation of some sort, a cursor indicating an input position on a screen is displayed, and processing in the computer or the like is performed in response to the input operation at the position of the cursor. For example, when document creation and editing software (referred to as word-processing software) is started-up on a personal computer, by appropriately manipulating the cursor on the screen, processing for character input, copying or cutting of a character string, and the like, at an arbitrary location in a document, can be performed from a keyboard.

Since this type of conventional cursor specifies a location that is an object of the user's input operation at some arbitrary point in time, ordinarily only one cursor is displayed on the screen of the display device. Exceptionally, in cases in which a plurality of users is sharing one display device, technology is known in which multiple cursors corresponding to the number of users are displayed on the screen of the display device. In that technology, in cases of a shared display device being jointly used by a plurality of meeting participants, by displaying the cursors, manipulated by each of the meeting participants, on the screen of the shared display device, locations that are objects of input operations by the respective meeting participants at arbitrary points in time are specified.

With the document creation and editing software, in many cases a document cannot be displayed in its entirety on one screen of the display device, so that normally, with the location in the document which the cursor is at, as reference, only a clipped portion, fitting the one screen, is generally displayed. In this regard, since the conventional cursor specifies the location that is the object of the user's input operation as described above, when it is desired to confirm or edit a portion that has not been an object of the input operation up to this point in time and is not displayed (a portion that is separate from the cursor position in the document), in actuality the user is obliged to perform time-consuming operations, having to scroll the display of the document on the screen and search for the relevant portion.

On the other hand, the document creation and editing software may have a window-splitting function for displaying different portions of the document on the one screen, and there are also cases in which it is possible to confirm portions that cannot be displayed in the normal display in which the cursor location is the reference. However, the fact remains that the user has to perform time-consuming actions of starting up the window-splitting function or scrolling the display within the window, case by case, according to the portion that requires confirmation or the like, and furthermore, when window-splitting is done, drawbacks occur in that the display area of the document itself on the screen becomes small, so that the portion of the document that can be confirmed at one time is decreased.

Furthermore, in editing with the document creation and editing software, often a region in the document is specified, and processing for copying or cutting a character string in that specified region is performed. In this regard, with the conventional cursor, since generally only one cursor is displayed on the screen as described above, what can be specified is limited to one continuous region. Accordingly, in order to perform processing for copying or cutting in a plurality of scattered discontinuous regions in the document, processing for copying or cutting must be repeatedly performed for each respective region, requiring operations that are time-consuming for the user. In cases in which these regions are scattered in portions of the document that are not displayed, operations such as the abovementioned scrolling or the like are additionally required, and the user is obliged to perform very time-consuming operations.

With the conventional cursor, there are cases in which the above types of time-consuming actions are required of the user, resulting in a large burden on the user, and document creation and editing operations become cumbersome. In particular, when handling a long document with the document creation and editing software, the user burden increases, and the document creation and editing efficiency deteriorates significantly. These types of issues are problems not only when using the document creation and editing software, and similar problems occur in cases of using software that utilizes a cursor when performing input operations with applications such as editors, spreadsheet software, and drawing software, and other situations. With the abovementioned conventional technology, since for each user there is no change in that one cursor is displayed on the screen for specifying a location as an object of his or her input operation, nor is there any change in that each user may be obliged to perform the time-consuming operations, and a solution to the related problems is not attained.

The present invention was made in view of these circumstances, and has as an object the provision of cursor management technology that, when performing input operations using a cursor displayed on a screen of a display device, can save effort required in cursor manipulation, reduce the burden when performing input operations, and realize improvements in convenience for cursor usage and input operations.

### SUMMARY OF THE INVENTION

In order to realize these objects, a cursor management method related to the present invention has a first process of storing a cursor position, specified by an input means for manipulating a cursor that is displayed on a screen of a display device, and a second process of making a position of a cursor that can be manipulated by the input means, the cursor position stored by the first process, when there has been a specification by the input means.

Here, the input means may specify cursor positions for a plurality of cursors, and the second process may make a position of a cursor that can be manipulated by the input means, a cursor position of a cursor selected, among the plurality of cursors, by the input means. Furthermore, the method may additionally have a third process of displaying on the screen of the display device, at the cursor position stored by the first process, the fact that there is a cursor storing a cursor position, and a display with a position of a cursor that can be manipulated by the input means as reference, may be made on the display device.

In addition, the input means may specify a region between cursor positions, the first process stores cursor positions identifying the region, as the specified cursor positions, and the method may additionally have a fourth process of performing processing on the region identified by the cursor positions stored by the first process.

Moreover, a cursor management program related to the present invention implements, in a computer, a first function of storing a cursor position, specified by an input means for manipulating a cursor that is displayed on a screen of a display device, and a second function of making a position of a cursor that can be manipulated by the input means, the cursor position stored by the first function, when there has been a specification by the input means.

According to the present invention, when the cursor position specified by the input means is stored and there has been a specification by the input means, since the position of the cursor that can be manipulated by the input means is made the stored cursor position, the position of the cursor that can be manipulated by performing a specification by the input means can be made an arbitrary cursor position that is stored in advance. In this way, user effort required in cursor manipulation can be saved and the burden when performing input operations can be reduced, so as to realize improvements in convenience for cursor usage and input operations.

### BRIEF DESCRIPTION OF THE DRAWINGS

FIG. 1 shows a configuration of an information processing device applied to a cursor management method according to an embodiment of the present invention;

FIG. 2 is a flowchart showing a cursor management procedure according to a cursor management program installed in a computer 2 of the same information processing device;

FIG. 3 shows an example of a specifying input mode when a user selects and executes “add cursor” on a screen of document creation and editing software displayed on a display device 3 of the same information processing device;

FIG. 4 is an example of a display on the display device 3 when a cursor is moved to the background after cursor addition processing has been executed;

FIG. 5 shows an example of the specifying input mode when the user selects and executes “delete cursor” on the screen of the same document creation and editing software;

FIG. 6 shows an example of the specifying input mode when the user selects and executes “select cursor” on the screen of the same document creation and editing software;

FIG. 7 is a flowchart showing a procedure for drag processing activated when the user performs a drag operation with a mouse 1b;

FIG. 8 shows an example in which a cursor is registered by the same drag processing, and region specifying is performed; and

FIG. 9 is a flowchart showing a procedure for copy/cut processing for performing copy or cut processing after the region specifying.

### DETAILED DESCRIPTION OF THE PREFERRED EMBODIMENTS

<Configuration>

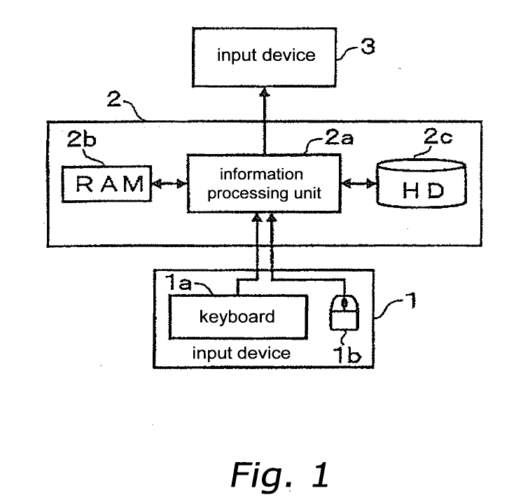

Below, an embodiment of the present invention is explained, referring to the figures. FIG. 1 shows a configuration of an information processing device applied to a cursor management method according to the embodiment of the present invention. The present information processing device comprises an input device 1, a computer 2, and a display device 3, as shown in the figure, and, more specifically, is realized by a widely and generally used personal computer or the like. Furthermore, although omitted from the figure, the present information processing device may also be provided with an image forming device, an external storage device, and other peripherals, in accordance with requirements.

The input device 1 is an input means by which a user of the present information processing device performs input to the computer 2, and comprises a keyboard 1a that accepts input by key operations such as character input and the like, and a mouse 1b that is a pointing device with which selection input and the like is possible by left or right clicking operations or dragging operations.

The computer 2 is an electronic computer in which a program is installed for implementing the present cursor management method, and comprises an information processing unit 2a, RAM 2b, and a hard disk 2c. The information processing unit 2a has a computation unit such as a CPU or the like for internally executing various types of computation, a storage unit composed of a semiconductor memory, such as nonvolatile memory such as ROM or the like, or cache memory or the like, for storing information such that it can be updated, and a control unit for administering various operations internally and giving and receiving information to and from outside, and it plays a central role in realizing the present cursor management method. The RAM 2b is semiconductor memory for storing information such that it can be updated, and is used as a multi-purpose storage area which the computation unit of the information processing unit 2a uses for computation. The hard disk 2c is a storage device for storing files for programs installed in the computer 2 and various data files and the like that are handled by the programs. This hard disk 2c stores, in addition to basic software program files such as the OS (Operating System), program files for the cursor management program for executing processing by the present cursor management method, program files for document creation and editing software and the like, in which a cursor is used when performing input operations, and data files such as document files and the like, handled by this document creation and editing software. Furthermore, since the RAM 2b in the computer 2b is the multi-purpose storage area that the computation unit of the information processing unit 2a uses when operating, in the electronic computer configuration, it may be considered as being included in the storage unit of the information processing unit 2a; however, with the storage operations particular to the present cursor management method, it is expressly shown as being separate (accordingly, in the hardware configuration of the electronic computer, a new separate RAM is not particularly needed.)

The display device 3 is a display means composed of a liquid crystal display, a CRT display, or the like, and it displays, on a screen thereof, predetermined information under the control of the information processing unit 2a of the computer 2.

<Operations>

Next, cursor management operations according to the present cursor management method in the abovementioned configuration are explained. With the present cursor management method, in applications such as the document creation and editing software and the like that use a cursor when performing input operations, by the user managing arbitrarily set cursor information as explained below, is it possible to perform input operations using an apparent plurality of cursors.

When using the document creation and editing software utilizing a cursor when performing input operations, cursor management operations are begun by starting up the cursor management program stored in the hard disk 2c. In the explanation of operations below, as one example of a start-up mode for this cursor management program, the cursor management program is set in advance as a cursor management tool for the document creation and editing software installed in the computer 2, and the cursor management program is started up by selecting and running the cursor management tool during execution of the document creation and editing software.

(1) Basic Operation

Initially, when the document creation and editing software is started up by a predetermined operation by the input device 1, a document screen, with one cursor only, is displayed on the display device 3. In this way, the user performs character input operations from the keyboard 1a, using the cursor, and normal input processing and edit processing with a single cursor are performed in the computer 2. At this time, if the user selects the cursor management tool, a menu for selecting among “add cursor”, “delete cursor”, and “select cursor” for execution processing is displayed on the screen of the display device 3, and by the user selecting an item for execution processing, the cursor management program is started up.

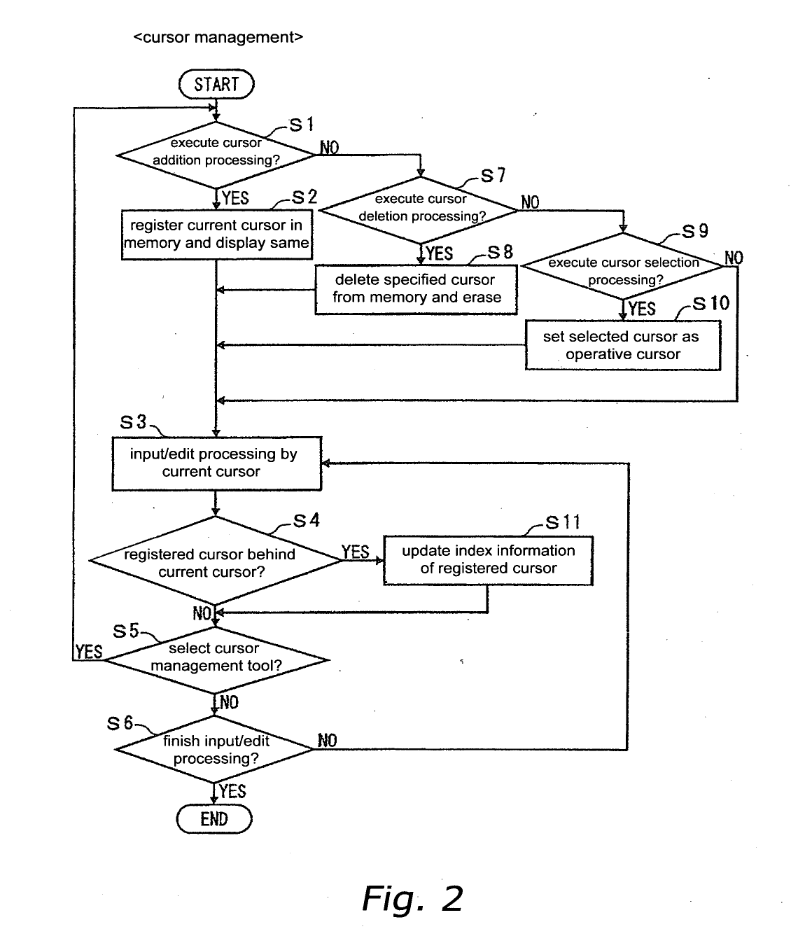

FIG. 2 is a flow chart showing a procedure for cursor management according to the cursor management program. At this stage, since there is only one cursor in the document displayed on the display device 3, if the user inputs an instruction to select and execute “add cursor” from the input device 1, the computer 2 receives this instruction and executes the cursor addition processing (a judgment result of step S1 is “YES”, and control proceeds to step S2.)

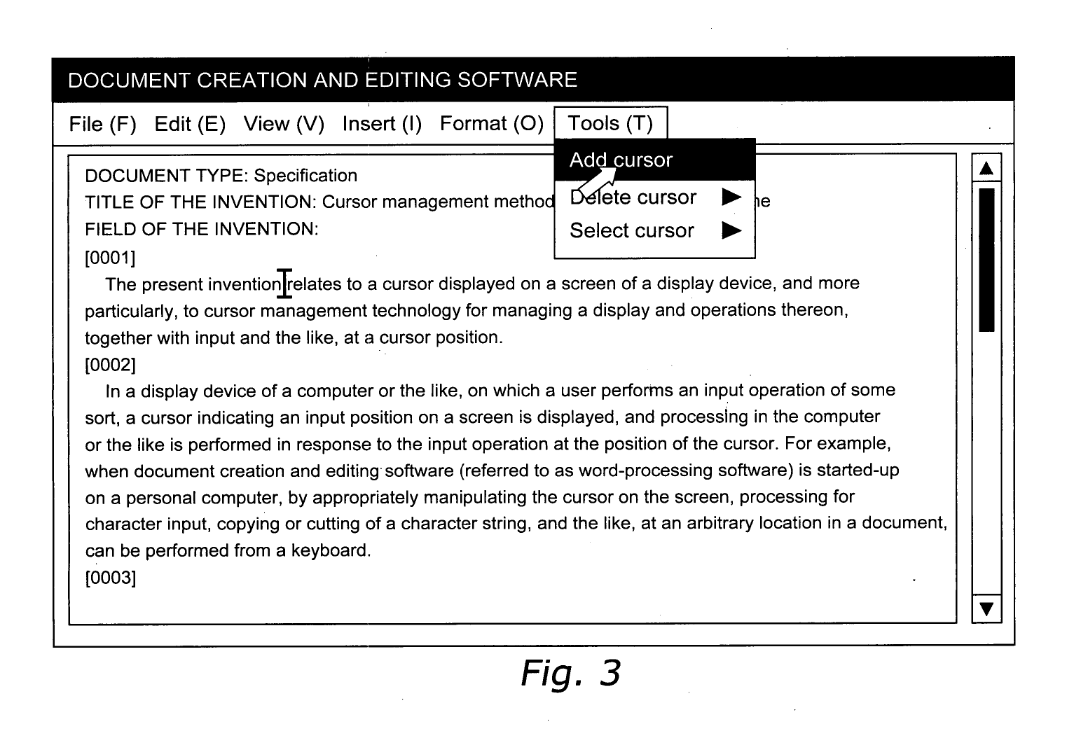

Here, instruction input from the input device 1 is performed as shown in FIG. 3. FIG. 3 shows an example of an instruction input mode when the user selects and executes “add cursor” on a screen of the document creation and editing software displayed on the display device 3. In FIG. 3, the area with “File (F) Edit (E) View (V) Insert (I) Format (O) Tools (T)” is the menu bar of this document creation and editing software, and the cursor management tool is installed in the “Tools (T)” of these menu items. The document being edited is displayed in the area under the menu bar, and a scroll bar for this document is displayed at the right edge. Furthermore, the opening section of the present patent specification is shown as a sample of a document being edited.

In the document being edited, an “I” mark between “The present invention” and “display device” on the fifth line is the cursor (referred to below as “current cursor”) that the user uses for a current operation. The position of this current cursor is specified by a user operation by the input device 1.

In FIG. 3, a mouse pointer that the user manipulates by the mouse 1b of the input device 1 is shown by an outline arrow. That is, the user operates the mouse 1b, and by moving the mouse pointer to “Tools (T)” and inputting a selection (for example, a left click operation of the mouse 1b) selects the cursor management tool; following that, by moving the mouse pointer to “add cursor” in the displayed menu, and inputting a selection, an instruction input is performed to execute cursor addition processing in the computer 2.

In the cursor addition processing, the computer 2 registers the current cursor in memory, and displays this registered cursor in a predetermined form on the display device 3 (step S2 in FIG. 2).

The procedure of registering in the memory is performed by the information processing unit 2a writing cursor information of the current cursor in the RAM 2b. Here, the cursor information is composed of cursor number, index information and a region specifying flag. The cursor number is an identification number of the cursor, sequentially assigned to an added cursor by the registration. The index information is information indicating the cursor position in the document, and the information processing unit 2a identifies the cursor position in the character data in the document file, corresponding to the position coordinates of the cursor on the screen of the display device 3 and the portion of the document being displayed, and the information indicating this identified cursor position is the index information. The region-specifying flag is a flag indicating whether or not the cursor is denoting a region-specifying location for copy or cut processing, and is not used if the cursor registration by a drag operation of the mouse 1b, described below, is not performed (the fact that it does not denote a region-specifying location is written in the RAM 2b).

In the processing for displaying the registered cursor, based on cursor information written in the RAM 2b, a display in which it can be visibly confirmed that there is a registered cursor (a cursor for which cursor information is stored in the RAM 2b; the same applies below), being a cursor number, in the cursor information, is displayed at an index information position in this cursor information. For example, the mark of a registered cursor, whose cursor display color, display density, shape, and the like, have been changed, is displayed in the index information position, and the cursor number together with this mark are displayed.

By this cursor addition processing, for the cursor in FIG. 3, cursor information that the cursor number is 1, and the index information is “position between ‘The present invention’ and ‘display device’” is stored in the RAM 2b and is registered in the memory, and the registered cursor with cursor number 1 is displayed between ‘The present invention’ and ‘display device’.

After executing cursor addition processing, an already registered cursor that overlaps the registered cursor with cursor number 1 now becomes a cursor that can be manipulated by the input device 1. Accordingly, the user performs operations with this cursor as the current cursor, and input processing or edit processing in response to the user's input operations are performed on the computer 2 (step S3 in FIG. 2).

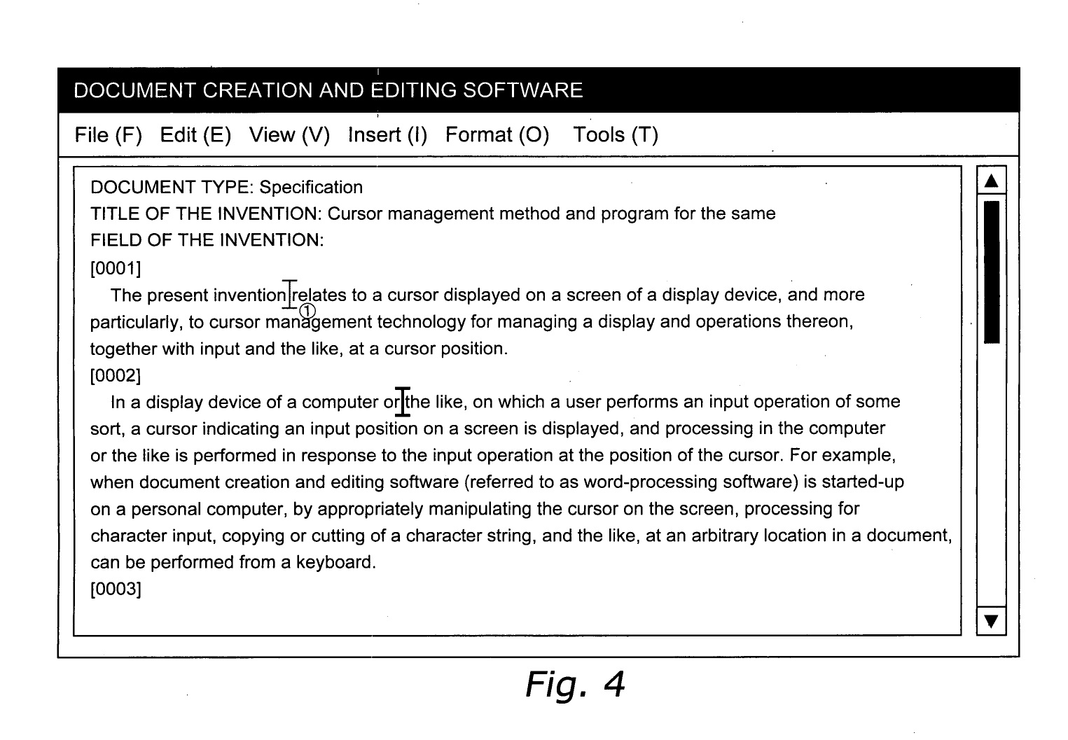

Here, when the user performs an operation to move the current cursor to the background only, the display on the display device 3 is as shown in FIG. 4. In FIG. 4, the moved current cursor is between “performs” and “computer” in the ninth line, the cursor registered by the instruction input of FIG. 3 as described above, is displayed as a similarly shaped mark with the cursor having a low density display, and the cursor number 1 is additionally displayed at the bottom right side of the mark.

On the other hand, in cases in which there is a registered cursor in the document, according to the position of the current cursor, when the user performs character input and the like, the position of the registered cursor becomes misaligned (a change occurs in the cursor information of the registered cursor). As a result, in the computer 2, the information processing unit 2a referring to the cursor information in the RAM 2b judges whether or not there is a registered cursor behind the current cursor (step S4 in FIG. 2). At this stage, the current cursor is at the ninth line, and since there is no registered cursor below this (a judgment result of step S4 is “NO”), the computer 2 does not perform any processing related to the cursor information. Additionally, the computer 2 performs judgment as to whether or not the user has selected the cursor management tool, by input from the input device 1 (step S5), and judgment as to whether or not input and edit processing have been completed (step S6); and as long as the user does not select the cursor management tool and does not end the input and edit processing, input processing and edit processing in response to the user's input operations are continued (judgment results of step S5 and step S6 are both “NO”, and control returns to step S3).

Next, the user again selects the cursor management tool, at the current cursor position shown in FIG. 4, and if an instruction is input to select and execute “add cursor”, the computer 2 again executes the abovementioned cursor addition processing (the judgment result in step S5 is “YES”, and control proceeds to step S1; the judgment result in step S1 is “YES” and control proceeds to step S2). In this way, cursor information with the cursor number as 2, and the index information as “position between ‘perform’ and ‘computer’” is stored in the RAM 2b and registered in the memory, and the registered cursor with cursor number 2 is displayed between “perform” and “computer”.

After the cursor for cursor number 2 is registered in this way, since the cursor that overlaps the registered cursor with the cursor number 2 then becomes a cursor that can be manipulated by the input device 1, with this cursor as the current cursor, input processing and edit processing in response to the user's input operations are performed in the computer 2 (step S3). However, if at this point in time the user judges that the registered cursor with cursor number 1 is unnecessary, and inputs an instruction to select the cursor management tool and execute “delete cursor”, the computer 2 receives this instruction and executes cursor deletion processing (with the judgment result at step S4 as “NO”, and the judgment result at step S5 as “YES”, control proceeds to step S1; with the judgment result at step S1 as “NO”, control proceeds to step S7; and with a judgment result at step S7 of “YES”, control proceeds to step S8.)

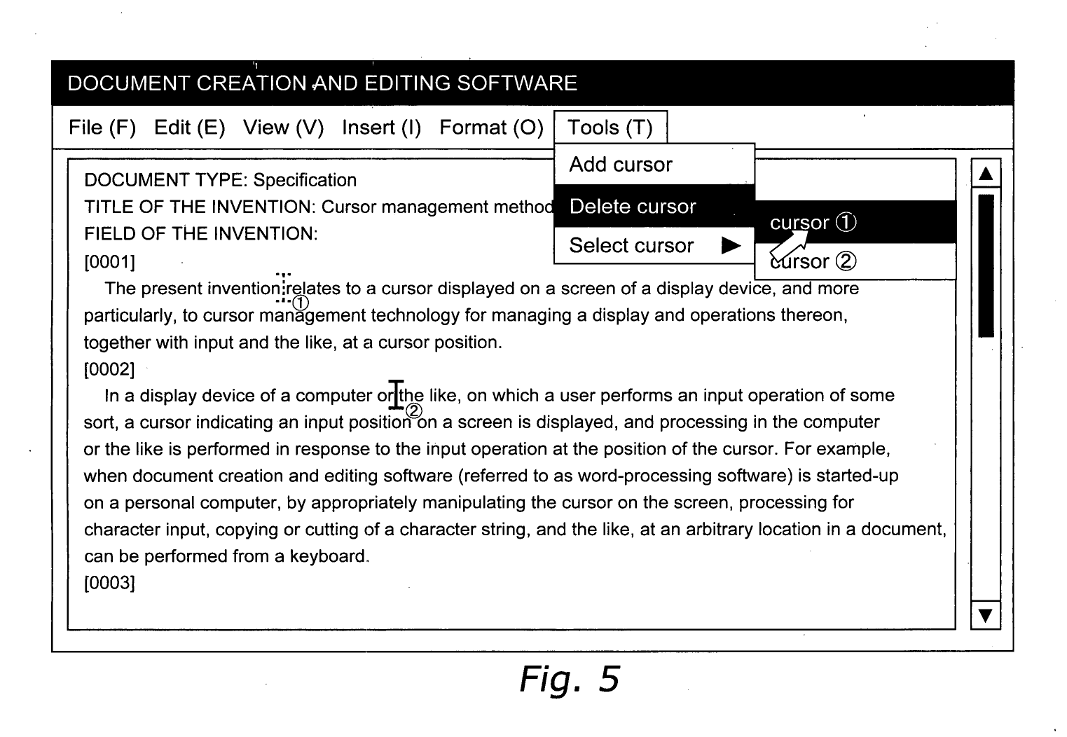

Here, the input instruction when deleting the registered cursor with the cursor number 1 is performed as shown in FIG. 5. FIG. 5 shows an example of an instruction input mode when the user selects and executes “delete cursor” on the screen of the same document creation and editing software as in FIG. 3. That is, by operating the mouse 1b to move the mouse pointer to “Tools (T)” and input a selection, the user selects the cursor management tool, and following that, points the mouse pointer at “delete cursor” in the displayed menu (the mouse pointer is moved to that position and halted). Then, a list of cursor numbers for all registered cursors is displayed as shown in the figure, and among these, by moving the mouse pointer to “cursor 1” that is to be deleted, and inputting a selection, an instruction is input to the computer 2 to execute cursor deletion processing. Furthermore, in FIG. 5, the registered cursor with cursor number 2, that was registered in the immediately preceding cursor addition processing, is displayed, and is overlapped by the current cursor.

In the cursor deletion processing, the computer 2 deletes from memory the registered cursor with the cursor number specified by the input selection by the mouse 1b, and also erases from the display device 3 the display of this for-deletion registered cursor (step S8 in FIG. 2).

Processing for deleting from the memory is performed by deleting the cursor information of the registered cursor, that was specified by the information processing unit 2a from the RAM 2b. Processing for erasing the display of the for-deletion registered cursor is performed, based on the for-deletion cursor information, by halting processing for displaying the registered cursor at a position in the index information of the cursor information.

According to this cursor deletion processing, for the registered cursor with cursor number 1, the cursor information with the cursor number as 1 and the index information as “a position between ‘The present invention’ and ‘display device’” is deleted from the RAM 2b and display of the registered cursor with cursor number 1, that was between “The present invention” and “display device” is erased. In FIG. 5, for convenience in representing this, the mark of the registered cursor with cursor number 1 is shown with a wavy line (the mark with the wavy line shown in the figure is not actually displayed on the screen of the display device 3; when the cursor deletion processing is completed, the display of the registered cursor with cursor number 1 disappears.)

In cases in which the user judges that the registered cursor with cursor number 1 is unnecessary and inputs an instruction for cursor deletion processing, cursor deletion processing is executed in this way; however, after execution of the cursor deletion processing, the user continues by manipulating the current cursor to perform input processing and edit processing in the computer 2 in response to the user's input operations (control proceeds from step S8 to step S3 in FIG. 2). Here, since the current cursor is at the position of the registered cursor with cursor number 2, the user performs cursor manipulation, character input, and the like, from that position.

On the other hand, after registering the cursor with cursor number 2, the user does not judge that the registered cursor with cursor number 1 is unnecessary, and when he or she wishes to move the current cursor to the position of the registered cursor with cursor number 1, the user selects the cursor management tool and inputs an instruction to execute “select cursor”; the computer 2 receives this and executes cursor selection processing (with the judgment result of step S4 as “NO”, the judgment result of step S5 is “YES”, and control proceeds to step S1; with the judgment result of step S1 as “NO”, control proceeds to step S7; with the judgment result of step S7 as “NO”, control proceeds to step S9; and with a judgment result of step S9 as “YES”, control proceeds to step S10.)

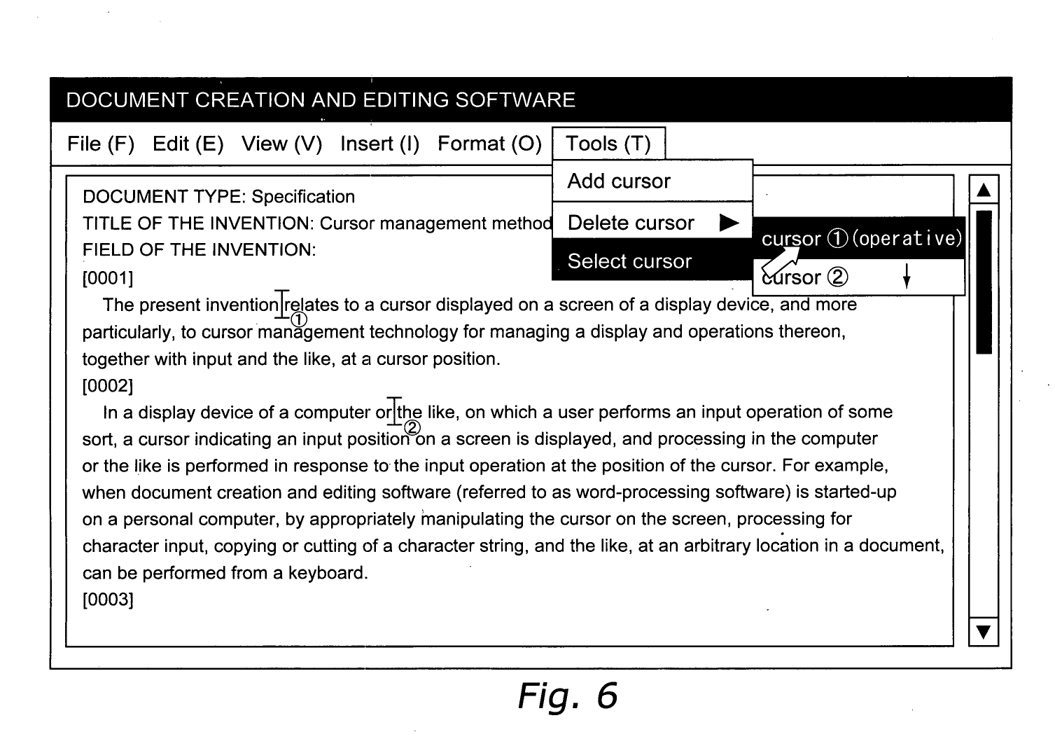

Here, the input instruction when selecting the registered cursor with cursor number 1 (the position of the current cursor is made the position of the registered cursor with cursor number 1) is performed as shown in FIG. 6. FIG. 6 shows an example of an instruction input mode when the user selects and executes “select cursor” on the screen of the same document creation and editing software as in FIG. 3. That is, by operating the mouse 1b to move the mouse pointer to “Tools (T)” and input a selection, the user selects the cursor management tool, and following that, points the mouse pointer at “select cursor” in the displayed menu. Then, a list of cursor numbers for all registered cursors is displayed, as shown in the figure, and among them, by moving the mouse pointer to “cursor 1” that is to be selected, and inputting a selection, an instruction is input to the computer 2 to execute cursor selection processing.

In the cursor selection processing, the computer 2 sets the registered cursor with the cursor number selected by selection input by the mouse 1b, as an operative cursor (a cursor with the same index information as the cursor that can be manipulated by the input device 1; the same applies below) (step S10 in FIG. 2).

The processing to set the operative cursor is performed by the information processing unit 2a referring to the index information of the selected registered cursor in the RAM 2b and changing to the position of the index information that refers to the position of the cursor that can be manipulated by the input device 1.

By this cursor selection processing, the registered cursor with cursor number 1 becomes the operative cursor, and the position of the current cursor that can be manipulated is moved to this cursor position. Ln FIG. 6, after the abovementioned instruction input has been done, the cursor selection processing is terminated at once, and a state is shown in which the current cursor overlaps the registered cursor with cursor number 1. Furthermore, as shown in the figure, in the cursor number list displayed by pointing to “select cursor”, the word “operative” is displayed beside the cursor number of the registered cursor set as being operative, and information indicating relative positions of other registered cursors with respect to the operative cursor (in the example shown in the figure, by upward or downward arrows) is displayed beside the cursor numbers. In this way, when the user executes “select cursor”, he or she can roughly grasp where the other registered cursors are relative to the registered cursor set as being operative the previous time.

After executing cursor selection processing, the user manipulates the current cursor that is at the position of the registered cursor, selected as the operative cursor, and input processing and edit processing in response to the user's input operations are performed in the computer 2 (control proceeds from step S10 to step S3 in FIG. 2). Here, since the selected operative cursor is the registered cursor with cursor number 1, when cursor selection processing is completed, the current cursor is at the position of the registered cursor with cursor number 1, and the user performs manipulation of the current cursor, character input, and the like, from this position.

The registered cursor with cursor number 2 is behind the registered cursor with cursor number 1. Accordingly, when the user, who has selected the registered cursor with cursor number 1, performs character input and character deletion without moving the current cursor, the position of the registered cursor with cursor number 2 becomes misaligned. In such cases, in the computer 2, the information processing unit 2a referring to the cursor information in the RAM 2b judges that there is a registered cursor behind the current cursor (the judgment result in step S4 is “YES”), and performs processing to update the index information of the registered cursor (step S11).

The processing to update the index information is performed by the information processing unit 2a rewriting the index information stored in the RAM 2b according to the number of characters the user has input or has deleted. That is, the information processing unit 2a rewrites the index information in the RAM 2b so as to update, regarding the registered cursor that is behind the current cursor, the cursor position the index information indicates, with only those portions corresponding to the number of characters the user has input or has deleted. In this way, the position of the registered cursor in the document that the user has selected is retained, and the user can perform input operations at the cursor position arbitrarily selected from a plurality of registered cursors.

Below, similar to what is described above, cursor addition processing, cursor deletion processing, or cursor selection processing, in response to the user's input instructions, are executed (from step S5, step S1 and step S2, step S7 and step S8, or step S9 and step S10); input processing and edit processing are performed at the position of the current cursor (step S3); and in cases in which the registered cursor is behind the current cursor, processing to update the index information is performed (step S4 and step S11). In this way, the user can arbitrarily set a plurality of cursors in the document, and can perform input operations and confirmation of document contents at cursor positions arbitrarily selected from the plurality of set cursors, and can easily perform editing of the whole document without using scroll bar and window-splitting functions.

That is, by executing cursor addition processing at an arbitrary cursor position specified by an operation by the input device 1, the user can freely increase the cursors in the document, and there are no constraints on the number of cursors added. Furthermore, since unnecessary cursors can be deleted anytime by cursor deletion processing, cursor arrangement can be done more appropriately, on a case-by-case basis. By cursor selection processing, since selection of which cursor, from among the set cursors, is made operative can be freely done, in the document creation and editing software with a display with the position of the current cursor as reference, it is possible to arbitrarily switch document portions displayed on the screen, and perform editing tasks. Even in document creation and editing software without this display, if a program that displays the current cursor position as reference is included in the cursor management program and is started up together with the cursor selection processing, it is possible to similarly arbitrarily switch document portions displayed on the screen, and perform editing tasks.

For example, by repeating the cursor addition processing and expanding the cursor information in the memory, various cursors being scattered at different positions in the document, it is possible to instantaneously switch the displayed portion of the document by switching the operative cursor. In particular, in cases in which a long document is being edited, in this way, the burden on the user is considerably reduced, convenience when the user is performing input operations using a cursor is improved, and document editing efficiency is increased.

Document creation and editing is performed using the cursor management tool as above, and when the user finally performs a predetermined operation to finish usage of the document creation and editing software, the computer 2 judges that input and edit processing are complete (a judgment result in step S6 is “YES”), and cursor management processing by the cursor management program is completed. Furthermore, the cursor information stored in the RAM 2b may be deleted at the same time as the cursor management program is completed, or, as an attachment to the document file of the edited document, may be stored on the hard disk 2c or the like, together with the document file (or a portion of the document file).

(2) Cursor Management for Drag Processing and Copy/Cut Processing

Basic cursor management operations according to the present cursor management method is as above. In the procedure shown in the flow chart of FIG. 2 as described above, in step S3 in which the input processing and the edit processing in response to the user's input operations are performed, there are cases in which copy and cut processing are performed by drag operations by the mouse 1b. In these cases, in normal copy or cut processing only a single continuous region can be specified; however, by executing cursor management processing described below, a discontinuous plurality of regions can be specified and copy or cut processing can be performed. Furthermore, the program for executing the processing below corresponds to a subroutine of the cursor management program.

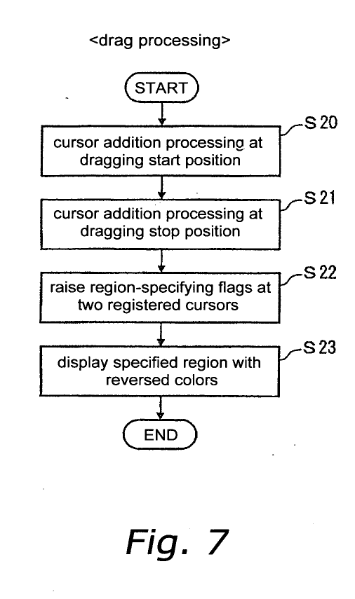

FIG. 7 is a flowchart showing a procedure for drag processing activated when the user performs a drag operation with the mouse 1b in step S3 of FIG. 2, as described above. In this drag processing, when the user operates the mouse 1b to drag the cursor, firstly, the computer 2 executes cursor addition processing at the start position of the dragging (step S20). The cursor addition processing here is performed by executing cursor addition processing in the same way as above, with the current cursor at the start position of the dragging. Next, the computer 2 executes the cursor addition processing at the stop position of the dragging (step S21). The cursor addition processing here is performed by executing cursor addition processing in the same way as above, with the current cursor at the dragging stop position. In this way, when the user drags the cursor, cursors are automatically assigned, respectively, to the starting edge and the finishing edge of the selected region, the index information respectively registers the cursor at the dragging start position and the cursor at the dragging stop position, and respective registered cursors at the dragging start position and the dragging stop position are displayed.

Next, the computer 2 raises region-specifying flags at the two registered cursors (step S22). That is, for index information with cursor information for the dragging start position and cursor information for the dragging stop position, the information processing unit 2a writes the region-specifying flags in the RAM 2b to show the region-specifying locations. After that, the computer 2, based on the region-specifying flags written in the RAM 2b displays, with color reversion on the display device 3, among the cursor information concerning where the region-specifying flags are placed, the area between positions indicated by the index information, as a specified region (step S23). In this way, index information, for a pair of registered cursors identifying the region that the user specifies by a dragging operation, is stored in the RAM 2b and is displayed in a mode that is visible to the user; and the drag processing is completed.

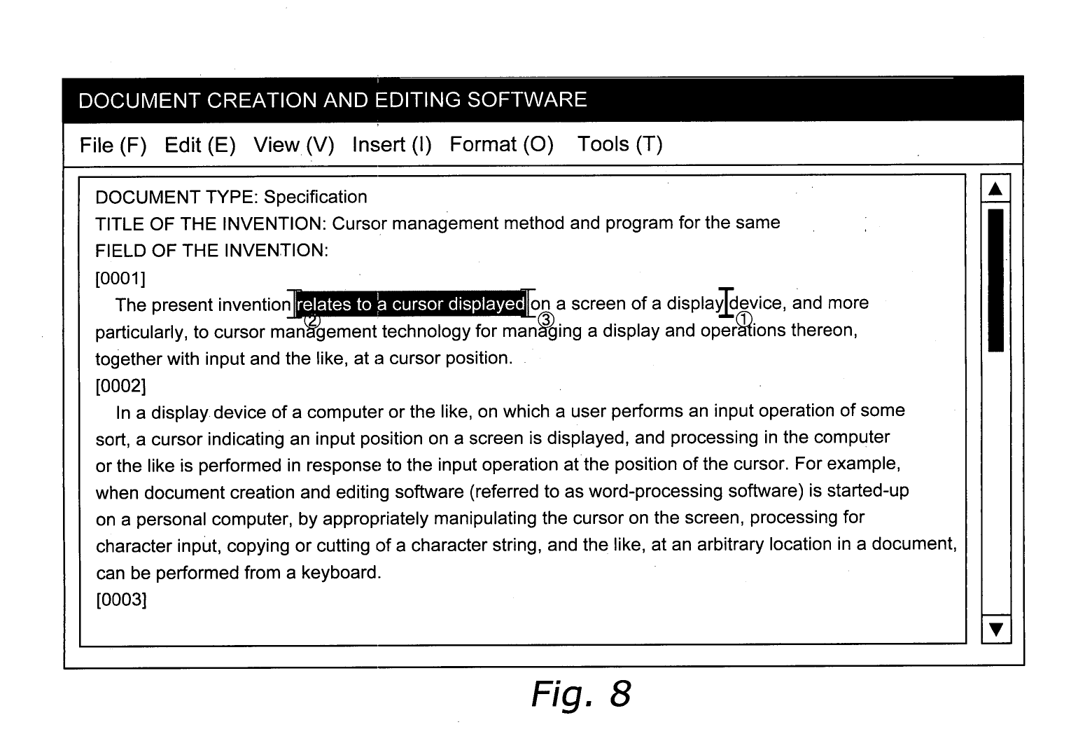

FIG. 8 shows an example in which a cursor is registered by the drag processing, and the region specifying is performed. In the example shown in the figure, the user performs a dragging operation, with a point on the fifth line of the document, between “The present invention” and “display device”, as the dragging start position, and a point between “screen” and “displayed on” as the dragging stop position; a registered cursor with cursor number 2 is displayed at the dragging start position, and a registered cursor with cursor number 3 is displayed at the dragging stop position; and the region between these registered cursors, “screen of the display device” is displayed with reverse colors as the specified region. Furthermore, the current cursor overlaps the registered cursor with cursor number 1, lying between “cursor” and “to” on the same fifth line.

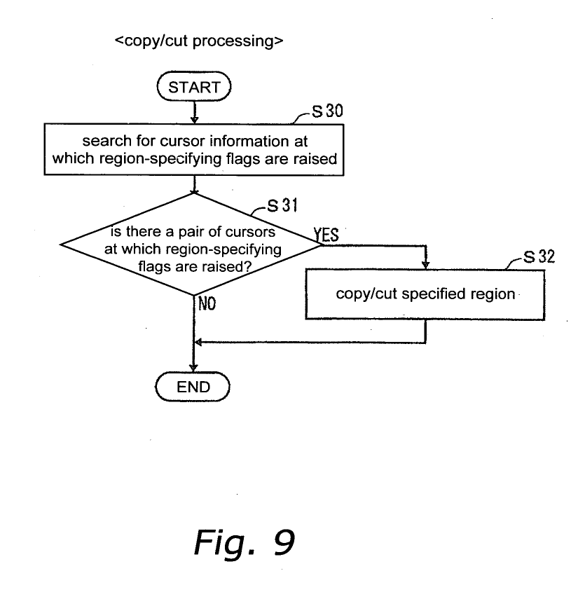

By the above drag processing, the user can specify an arbitrary discontinuous plurality of regions by repeating the dragging operation by the mouse 1b. Copy or cut processing of the specified region is performed by starting up the copy/cut processing shown in the flowchart shown in FIG. 9. The startup mode for this copy/cut processing may be arbitrarily set; however, for example, when a right click operation of the mouse 1b is performed for a copy destination or a paste destination position on the screen, copying and pasting of the specified region may be displayed as a menu item, and may be activated by making a selection with a left click operation.

Now, if the user activates the copy/cut processing, in the computer 2, the information processing unit 2a refers to the region-specifying flags in the RAM 2b and searches for cursor information in which the region-specifying flags are raised (step S30). In this way, when there is a pair of registered cursors at which the region-specifying flags are raised (a judgment result in step S31 is “YES”), the specified region, identified by these registered cursors, is copied or cut and pasted (step S32), and the copy/cut processing is completed. Furthermore, when there is no pair of registered cursors in which the region-specifying flags are raised (the judgment result in step S31 is “NO”), the copy/cut processing is completed without performing the copy or cut processing.

For example, if the user repeats the dragging operation by the mouse 1b, and by the abovementioned drag processing specifies a discontinuous plurality of regions, and then activates copy/cut processing, processing can be performed to copy or to cut and paste, at one time, the user-specified discontinuous plurality of regions. In this way, compared to a conventional situation where only one cursor is displayed on the screen, editing functions are dramatically expanded for the user, and convenience in using the cursor and in input operations is greatly improved.

Here, in cases where the specified plurality of regions is pasted by copy or cut processing, the pasting may be done by putting the region specified first at the beginning, and linking the sequentially specified regions in a specified order; or conversely, the pasting may be done by inserting the sequentially specified regions in a specified order so that the region specified first is at the end (the pasting order may be arbitrarily set). Furthermore, in cases where cut, not copy, processing is performed, at the point in time when the pasting is performed, the specified region that becomes blank is deleted.

In addition, since the registered cursors at which the region-specifying flags is raised can also be set as operative cursors by the abovementioned cursor selection processing, there are cases in which the current cursor is moved to the position of the region-specifying registered cursors. In such cases, at the point in time when the current cursor is moved to the position of the registered cursor, the region specifying may not be released, and when the current cursor is moved from there, the registered cursor may release one edge of the specified region (the region-specifying flags are rewritten so as not to show a region-specifying location).

### EXAMPLES OF MODIFICATIONS AND APPLICATIONS

(1) Information Processing Device

The information processing device applicable to the present cursor management method may be any device having functions of the input device 1, the computer 2 and the display device 3 described above. Accordingly, there is no limitation to a stand-alone personal computer or the like, and the present cursor management method can be applied to a network terminal, a server, a workstation, a word processor, or the like. For example, in a network in which a shared image forming device acts as a server, the present cursor management method may be applied to a terminal computer thereof or the image forming device that forms the server. In addition, as an instruction input means for the cursor addition processing and the like, there is no limitation to the abovementioned type of mouse; other pointing devices such as a slide pad, a trackball, or the like, may be used, or a device in which instruction input is performed by key operations on a keyboard is also possible.

(2) Cursor Information Storage Means

In the abovementioned embodiment, the RAM in the computer is used as a storage means for the cursor information; however, other storage means may also be used. Although dependent on storage size and access speed, for example, a hard disk or cache memory may also be used as the storage means for the cursor information.

(3) Cursor Management Tool

In the abovementioned cursor management tool, in cases in which a deleted registered cursor was set as an operative cursor, after confirming the position of this registered cursor, the user inputs an instruction for cursor deletion processing. Here, in such cases, among the registered cursors the newest one is set as the operative cursor, or the registered cursor that was selected as the operative cursor the previous time may again be set as the operative cursor.

(4) Cursor Number

In the present cursor management method, the assignment pattern for cursor numbers is arbitrary, and may be done in ascending order with respect to cursor registration sequence, or may be done in descending order. In the above described embodiment, the registration sequence was done in the ascending order; however, in cases in which the descending order is used, whenever the cursor addition processing is executed, the cursor number of the registered cursor is incremented, and the cursor number of a newly registered cursor may be 1. Furthermore, the display mode of the cursor number on the screen is arbitrary; and according to the case, this need not be carried out.

(5) Target Software

The present cursor management method is not limited to the abovementioned type of document creation and editing software and may be applied to applications such as other document creation and editing software, editors, spreadsheet software, drawing software, and the like; if software involves usage of a cursor when performing input operations, the present cursor management method can be applied. Here, since the present cursor management method is not constrained by the cursor display mode, it can be applied to various software cursors displayed as marks, symbols, underbars, blinking marks, or the like, other than the “I” mark of the above described embodiment. However, with regard to input operations at the cursor position, when the position of other data does not move (for example, in spreadsheet software, bitmap-related drawing software, and the like), processing to update the abovementioned index information (step S11 in FIG. 2) is not necessary.

What is claimed is:

1. A cursor management method comprising
a first process of storing a cursor position, specified by an input means for manipulating a cursor that is displayed on a screen of a display device, and
a second process of making a position of a cursor that can be manipulated by the input means, the cursor position stored by the first process, when there has been a specification by the input means.

2. The cursor management method according to claim 1, wherein the input means specifies cursor positions for a plurality of cursors, and the second process makes a position of a cursor that can be manipulated by the input means, a cursor position of a cursor selected, among the plurality of cursors, by the input means.

3. The cursor management method according to claim 1, further comprising a third process of displaying on the screen of the display device, at the cursor position stored by the first process, the fact that there is a cursor storing a cursor position.

4. The cursor management method according to claim 1, wherein a display, with a position of a cursor that can be manipulated by the input means, as reference, is implemented on the display device.

5. The cursor management method according to claim 1, wherein the input means specifies a region between cursor positions, and the first process stores cursor positions identifying the region, as the specified cursor positions, the method further comprising a fourth process of performing processing on the region identified by the cursor positions stored by the first process.

6. A program for implementing in a computer, the program comprising
a first function of storing a cursor position, specified by an input means for manipulating a cursor that is displayed on a screen of a display device, and
a second function of making a position of a cursor that can be manipulated by the input means, the cursor position stored by the first function, when there has been a specification by the input means.
